(19) United States
(12) Patent Application Publication
(10) Pub. No.: US 2013/0287892 A1
(43) Pub. Date: Oct. 31, 2013

(54) MILK PROTEIN CONCENTRATES

(71) Applicant: Ralph J. Knights, Benicia, CA (US)

(72) Inventor: Ralph J. Knights, Benicia, CA (US)

(21) Appl. No.: 13/460,034

(22) Filed: Apr. 30, 2012

(51) Int. Cl. A23J 1/20; A23C 1/14; A23J 3/10; A23J 1/22; A23C 9/158; A23C 9/152

(52) U.S. Cl. 426/42; 426/580; 426/72; 426/491; 426/588

(57) ABSTRACT

A method for making a milk protein concentrate can comprise heating a liquid milk composition at near its natural pH to a temperature that causes the whey protein in the milk to bind to the casein in the milk to form protein aggregates. After cooling, the liquid milk composition can be subjected to membrane filtration using a membrane filter having a large pore size. The protein aggregates are retained to yield a milk protein concentrate. The concentrate can be further treated to provide a concentrate having a lowered lactose content.

### BACKGROUND

Milk concentrates are a common way of making the proteins and nutrients of milk available for nutritional uses, particularly where storage or transport of milk may be impractical, due to its weight, volume, rapid perishability, or other considerations. Milk proteins are a particularly valued nutritional supplement in a variety of nutritional applications, and can be used as ingredients in many processed and prepared foods.

Effectively concentrating milk components to obtain concentrated protein products typically involves separating casein and/or whey from smaller molecular weight components of milk using porous membrane filters in a process called ultrafiltration. Milk proteins are concentrated by applying sufficient pressure to the milk to force water and low molecular weight components through the porous membrane filter while the proteins, fat, and insoluble minerals are retained. Material passing through the membrane is termed the permeate, and material not passing through the membrane is termed retentate. Typically, milk proteins are concentrated by ultrafiltration to a concentration two- to five-fold over the level in the starting milk. However, the viscosity of the retentate and the dynamics of the membrane filtration process can limit the potential concentration.

Diafiltration is a similar membrane filtration process, typically paired with ultrafiltration, wherein water or other diluent is added to the concentrated retentate at or about the same rate that the permeate is removed. Thus, the volume of the retentate may not change much during the process of diafiltration, but the low molecular weight materials are continuously removed from the high molecular weight components in the retentate.

The membrane filters used in these processes are selected to have a pore size that will retain the protein needed. While large pore sizes are sufficient to retain large molecules and micelles (e.g. caseins), much smaller pore sizes can be needed to retain smaller proteins. Methods providing ready retention of proteins can be useful in producing concentrated milk products.

### SUMMARY

The present invention provides methods of making milk protein concentrates. In one embodiment, such a method can include the steps of preparing a liquid milk composition having a pH of from about 6.5 to about 7.0, and that includes whey protein, caseins, and lactose; heating the liquid milk composition at that pH to a temperature that causes the whey protein to adhere to the caseins, thereby producing protein aggregates; cooling the liquid milk composition; subjecting the liquid milk composition to membrane filtration using a membrane filter having a molecular weight cut-off of from 100,000 to 1,000,000 daltons; and retaining the protein aggregates to yield a milk protein concentrate having retained solids and less than about 5 wt % moisture. This concentrate has a total protein content of from 60 wt % to 90 wt % of said retained solids.

In another embodiment of the present invention, a method for making a low-lactose milk protein concentrate can include the step of providing a liquid milk composition having a pH of from about 6.5 to about 7.0. The liquid milk composition comprises initial solids having whey protein, caseins, and lactose present in an amount of from 9 wt % to about 25 wt % of the initial solids. The method can further include heating the liquid milk composition at that pH to a temperature that causes the whey protein to adhere to the caseins, so producing protein aggregates; cooling the liquid milk composition; subjecting the liquid milk composition to membrane filtration using a membrane filter having a molecular weight cut-off of from 100,000 to 1,000,000 daltons; retaining the protein aggregates to yield a milk protein concentrate comprising retained solids and less than about 5 wt % moisture, and having a total protein content of from 60 wt % to 90 wt % of the retained solids and lactose present at from about 2 wt % to about 20 wt % of the total protein content; and adding an amount of lactase sufficient to reduce the amount of lactose to less than about 2 wt % relative to the total protein content.

According to particular embodiments the total protein content of the milk protein concentrate can be from about 65 wt % to about 75 wt % of the retained solids or, more particularly, about 70 wt % of the retained solids. Additionally, the milk protein concentrate can have a whey protein content of from about 15 wt % to about 25 wt % relative to the total protein content.

According to another embodiment of the present invention, a milk protein concentrate can include a total protein content of about 60 wt % to about 80 wt %, said total protein including caseins and whey protein. The concentrate can also include lactose present at less than about 2 wt % relative to the total protein content.

According to another embodiment of the present invention, a nutritional product can include a milk protein concentrate. The milk protein concentrate itself can include solids having a total protein content of about 60 wt % to about 80 wt %, said total protein including caseins and whey protein; and also lactose present at less than about 2 wt % relative to the total protein content.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “a milk product” includes reference to one or more of such milk products and “filtering” includes one or more of such steps.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” crosslinking would either completely lack crosslinking, or so nearly completely lack crosslinking that the effect would be the same as if crosslinking were totally absent. In other words, a composition that is “substantially free of” an ingredient or element may still actually contain such item as long as there is no measurable effect thereof.

As used herein, the term “serving” refers to an amount of a drink or food that is proportioned for consumption by a single individual subject as a meal or portion thereof. The amount can be designated from an industrial standard or widely-accepted nutritional guidelines. One example is the standard serving sizes promulgated by the United States Food and Drug Administration. In such a standard, the serving size typically depends on the food and/or the typical package in which the food is provided, e.g. a serving of milk can be 8 oz., while a serving of bread can be two slices of bread. The present invention sets forth novel methods of making concentrated milk products.

Milk is composed of water, fat globules, lactose (milk sugar), some soluble salts, some insoluble salts (calcium and magnesium phosphate), and two types of proteins (whey and casein). Whey proteins constitute approximately 18% of the proteins in milk with the other approximately 82% of the protein being casein. Whey proteins are soluble proteins of about 14,000 to 200,000 daltons molecular weight (MW) and exist in nature primarily as monomers and dimers. The whey proteins are soluble in saturated salt solutions and in particularly in solutions that are between pH 4 and pH 5. Whey proteins exhibit extremely high bioavailability, making them an efficient and rapid source of amino acids and energy.

The casein proteins of milk have a molecular weight of about 10,000 to 20,000 daltons each, but exist in natural milk primarily as large aggregates associated with calcium phosphate in structures termed micelles. These micelles have been described as having a diameter of approximately 100-250 nanometers and having a molecular weight of about 2-20×10⁸ daltons. Micelles typically contain several thousand molecules of casein, and can exhibit molecular weight of several million daltons. In the digestive system, casein micelles provide sustained slow release of amino acids into the blood stream, sometimes lasting for several hours. Between pH 4 and 5, the caseins are precipitated in a curd while the whey proteins remain soluble.

Concentrated milk protein products are available as milk protein concentrates and milk protein isolates. According to an industrial standard, a “protein isolate” is a product in which protein constitutes more than 90% of the solids (i.e. everything but moisture). Products having lower protein percentages are often termed “protein concentrates”. The term “protein concentrate” or “concentrate” as used herein refers to both of these classes of products unless an isolate is specifically indicated.

The process of ultrafiltration separates dissolved or suspended solids using a polymeric filter that is made to have consistently sized holes formed in the membrane. These holes, or pores, are made to have diameters that will allow small molecules like water and sugars, to pass through the membrane but large molecules like proteins are retained because they are larger than the pores. Ultrafiltration membranes are typically categorized by the smallest molecular weight material that is 90% retained by the membrane filter. This categorical molecular weight is termed the Molecular Weight Cut Off (MWCO). The MWCO for ultrafiltration membranes as designated by various manufacturers can range from 2,000 to 100,000 daltons, usually one of 2,000, 10,000, 50,000 and 100,000 daltons.

Filtered milk protein isolates are fairly common and come in three basic forms:

Type 1: Whey Protein Isolates—these have no casein proteins, and are made by ultrafiltering the liquid removed during the process of making cheese.

Type 2: Micellar Casein—this type of milk protein isolate has casein but no whey protein, and it is made by microfiltration rather than ultrafiltration, using a membrane filter with pores large enough to retain the micelles (casein) while allowing most other components to pass through. Micellar casein comprises the major proteins of milk, the casein proteins, and a major portion of the calcium and magnesium phosphate from milk. The whey proteins or serum proteins of milk are removed along with the lactose and soluble minerals because these proteins, sugars and minerals are small enough to pass through the pores of the microfilter.

Type 3: The third type has both casein and whey proteins and it is typically made using a membrane filter that allows neither casein nor whey to pass through. One such filter that is typically used is a membrane filter having a molecular weight cut-off (MWCO) of about 10,000 (also termed a 10K filter). When milk is ultrafiltered using a 10,000 MWCO membrane, all of the proteins and fat globules are retained, and the milk sugar, lactose, and the soluble minerals (sodium and potassium salts) pass through the membrane. Most of the calcium salts are closely associated with the proteins so these salts are mostly retained, depending on the pH and other treatments that may dissociate the Calcium away from the proteins. In this product, the caseins remain in micelles and the whey proteins remain loose, unassociated and soluble.

Retaining whey proteins in addition to caseins can result in a product with a higher total protein content, and therefore a potentially higher nutritional value. However, the small pore size required for such products results in low filtration flow rates, making the process time-consuming and expensive. Furthermore, during storage disulfide bonds tend to form between the unassociated, soluble whey proteins. This results in lowered shelf-life due to age gelation, i.e. the formation of gel in the concentrate due to crosslinking between whey proteins.

In accordance with these considerations, processes are described herein for treating milk compositions to provide a milk protein concentrate that can be used to provide protein, calcium, and other nutrients to food compositions and that exhibits improved shelf life and heat stability compared to compositions made with current milk protein ingredients.

According to the embodiments herein, an approximately neutral liquid milk composition, can be treated by heating, cooling, and ultrafiltering with large pore size membrane filters. The liquid milk compositions as discussed herein include without limitation skim milk, concentrated skim milk, reconstituted powdered skim milk, nonfat milk, milk protein concentrate, and milk plus added whey protein. In a particular aspect the process can be used to create a further concentrate from a milk protein concentrate having a total protein concentration of from about 42 wt % to about 70 wt % of the solids present in the composition.

The present embodiments provide a milk protein concentrate with the whey proteins bound to, or associated with, the casein proteins. This can have the subsequent effect of limiting interactions among whey proteins, especially those leading to physical changes such as gelling or separation. In a particular embodiment, the process can further include diafiltering the treated composition.

In one embodiment, a method for making a milk protein concentrate can comprise heating a liquid milk composition at near its natural pH to a temperature that causes the whey protein to become substantially insoluble and to adhere to the casein micelles. When milk is heated above about 80 ° C., the whey proteins become denatured. This forewarming causes the whey proteins to denature. The denatured whey proteins then bind with one another to form inert aggregates or they bind to the caseins to produce a stabilized milk composition.

The use of heated milk with the whey proteins bound to or associated with the casein or otherwise aggregated can provide an improvement to membrane filtration, since membranes with large pore sizes can be used for retention of both the large casein aggregates as well as the much smaller whey proteins that are bound to, or associated with, the caseins, and also large aggregates of whey proteins. Accordingly, the present method can comprise heating the milk composition to a temperature of about 80 ° C. to about 150 ° C.

The natural pH of milk is typically within the range 6.5 to 7.0, or more particularly within the range 6.75 to 6.9. According to the present embodiments, the milk composition is within this pH range when heated. In a particular embodiment, the milk may be heated at the pH at which the milk is obtained. Alternatively, the pH of the milk may be adjusted to a pH within the natural pH range. In a specific example, the pH may be adjusted to a value between about 5.0 and about 6.5 so as to solubilize a portion of the calcium without precipitating the casein protein.

Upon cooling, the liquid milk composition is subjected to membrane filtration. In a particular embodiment, ultrafiltration is employed. Due to the large size of casein micelles, and particularly the aggregates formed by binding of whey protein to casein micelles, substantially all or at least a substantial majority of the milk proteins in the composition can be retained with a membrane filter having a very large pore size. Membranes with large pore sizes have a high flux rate and the time involved in ultrafiltration can therefore be greatly reduced. This can also be true for subsequent steps in the concentrating process, such as diafiltration of the retentate. In an embodiment, a membrane filter can be selected that has a pore size that will substantially retain the whey-casein protein aggregates. For example, such filtration can be done with a membrane filter having a molecular weight cut-off of from 50,000 to several millions of daltons. In a particular embodiment, the method includes using a membrane filter having a molecular weight cut-off of from 100,000 to 1,000,000 daltons.

The method can optionally include a diafiltration step performed after concentrating the milk composition by ultrafiltration. A typical diafiltration process can involve passing fluid through the retentate in a filter at a known rate. For example, fluid can be passed through retentate at a rate so as to maintain a constant volume of retentate throughout the process. Diafiltration can provide further concentration of the milk proteins as well as removing soluble or suspended small molecular weight materials. In the present embodiments, efficient filtration is possible with large pore sized membrane filters. The increased flux rates associated with using large pore sizes can significantly shorten the diafiltration process. In a particular aspect, a diafiltration step can be shortened by a factor of up to 10 as compared to conventional methods of making high percentage protein concentrates.

The retained protein solids from this process can provide a milk protein product in which milk proteins have been greatly concentrated. Typically, ultrafiltration as a single process can produce a concentration factor of from 2 to 5 (i.e. where the retentate volume is from one-half to one-fifth of the original volume of milk) Combining diafiltration with ultrafiltration can produce concentration factors of up to 300. The actual concentration factor achieved will depend in part on the filters used. In one aspect of the invention, the filtration step(s) produce a retentate that comprises predominantly solids so that the weight percentage contributed by moisture is insignificant. The weight percentage of total protein in concentrates according to the present embodiments as expressed herein are percentages of the solids weight. It should be understood, however, that such a weight percentage can also be considered an approximate measure of the protein content as a percentage of the whole concentrate unless otherwise indicated.

In a particular embodiment, the milk protein concentrate has a total protein content of from about 60 wt % to about 90 wt % of the solids. In a more particular embodiment the total protein content is from about 65 wt % to about 75 wt % of the solids. In a still more particular embodiment, the total protein content is about 70 wt % of the solids.

By the processes of the present invention, the total protein content comprises a significant amount of whey protein which otherwise would not have been retained by large-pore filters. As such, the advantages of higher flux rate and higher retained protein content are combined in the present method. In a particular embodiment, whey protein constitutes from about 15 wt % to about 18 wt % of the total protein content. In another embodiment of the invention, whey protein is added to the milk prior to heating and processing. This increases the whey protein to between about 18 wt % and about 25 wt % of the total protein and most of the added whey protein is recovered in the protein that is retained by the large pore size membrane filtration steps.

The processes of the present invention can have an additional aspect of producing milk protein concentrates that have enhanced shelf life, or that impart enhanced shelf life to products. Sterilized liquid food products are typically made so that they can be stored for 12 to 18 months at, or about, room temperature before they are consumed. Products that remain consistent in character for 12 to 18 months are said to have a “long shelf life”. Sterilized liquid products with high concentrations of milk proteins can exhibit undesirable characteristic changes during storage, especially if the product also contains calcium, magnesium or other polyvalent cationic salts. Over the shelf life of a product, milk proteins can associate with each other or with polyvalent cations to increase the viscosity, produce a gel, form lumps, and settle out of solution. One aspect of concentrates made by the methods herein is that binding the whey proteins to the casein micelles reduces the amount of free unassociated whey proteins available for disulfide crosslinking. In a particular embodiment, the concentrate is substantially free of crosslinking among whey proteins. As a result, milk protein concentrates according to the present invention can exhibit reduced gelation during storage and have a significantly longer shelf life as compared to other whey-containing concentrates.

The methods of the present embodiments can also be directed to providing low lactose or lactose-free milk protein concentrates. Membrane filtration of skim milk results in a separation of lactose from the protein because of the size difference between the two molecules. As the milk is further concentrated by filtration processes, the ratio of protein to lactose increases. Making compositions with a high ratio of milk protein to lactose usually involves ultrafiltration to concentrate the solids, and then continuing the process by adding water (i.e. diafiltration) to remove more small molecules, during which more lactose is removed in the permeate. By this approach, a wide range of protein-to-lactose ratios can be obtained. As such, the methods as described above can provide low lactose milk protein products. Nutritional beverages with milk protein generally have a high protein content and are relatively low in lactose.

However, it can be of further benefit to make a product that is even lower in lactose or that is significantly free of lactose. By a convention, “lactose free” compositions are those providing less than 0.5 grams of lactose per serving. High ratios of protein to lactose can be one desired aspect in a nutritional drink. For example, a serving (8 oz.) of skim milk provides 3.4 grams of protein and 4.8 grams of lactose (i.e. a protein-to-lactose ratio =0.7). Eight ounces of a nutritional beverage providing 5 grams of protein and 0.5 grams of lactose has a protein-to-lactose ratio of more than 10. To extend the example further, preparation of a lactose-free nutritional beverage with 25 grams of protein per serving requires a protein-to-lactose ratio greater than 25/0.5, i.e. greater than 50. However, ingredients and beverages with a high ratio of protein to lactose are more resource-intensive than those with a lower ratio because obtaining high ratios involve extensive filtration. This can include use of larger membrane equipment and longer processing times, which in turn produces more by-products (e.g. lactose and minerals in permeate water). Furthermore, removal of lactose from protein by diafiltration tends to follow more of a logarithmic progression than a linear progression. That is, the lower the lactose content, the harder it is to remove it by dilution and filtration.

Accordingly, in another embodiment, either the starting liquid milk composition or the concentrated composition is treated with a lactose modifying enzyme. More particularly, a lactose modifying enzyme can be added to the milk protein concentrate to reduce the lactose content in the concentrate. For example, most of the lactose in a milk protein concentrate made by the present methods could be converted to glucose and galactose by adding a β-galactosidase. Accordingly, in a specific embodiment the enzyme is lactase. In one aspect, the lactose content in the concentrate is reduced to below 2 wt % of the total protein content. In a more particular aspect, a lactose content of from about 2 wt % to about 20 wt % of the solids in the milk protein concentrate can be reduced to below about 2 wt % of the solids. Addition of any of a flavoring, a selection of carbohydrates, fat, vitamins, and minerals to the treated composition can provide a low-lactose or lactose-free liquid composition that can be sterilized by conventional techniques, including use of a retort or aseptic heat treatments, to produce a food composition suitable for providing protein and other nutrients in a low lactose or lactose free liquid that has improved shelf life characteristics.

Another benefit of using milk that has been heated according to the present invention is a savings in diafiltration time or diafiltration water to obtain protein-to-lactose ratios greater than 50. In one aspect, the savings can include from 40% to 50% less time or water used in diafiltration. Less diafiltration time could also mean using less membrane equipment in filtration, and using less diafiltration water means less by-product permeate to process.

The calcium ions present in milk products, and particularly calcium trapped in casein micelles, can contribute to crosslinking and gelation in concentrates and isolates. When the pH of the starting milk is lowered to a more acidic range, a significant fraction of the calcium can be removed from the protein during filtration processing. Accordingly, the present methods can include adjusting the pH of the liquid milk product or the milk protein concentrate to between about 5.0 and about 6.5. More particularly this can be done by adding acids or buffers to the composition at some point in the process. Buffers that are suitable for such use are known in the art, and include citrate buffers, phosphate buffers, and the like. In a more particular embodiment of the process, a calcium binding buffer can be used to adjust the pH of the milk. Citrate buffers in particular have been found to bind some of the calcium in milk, rendering the calcium soluble and allowing it to be removed in the permeate stream. Reducing the soluble calcium concentration has a beneficial effect on increasing the heat stability of food compositions with this improvement.

In additional embodiments of the invention, the milk protein composition may be dried to yield a powder. Such a powder can be used with water or a water containing food ingredient plus added nutrients and flavors to make shelf stable liquid compositions. Also, the concentrated milk composition plus added flavor, carbohydrate, fat, vitamins and minerals may dried for subsequent reconstitution as a beverage or gel. In another aspect the concentrated milk composition may be dried and used as a source of protein and calcium in other low lactose or lactose free foods such as soups, sauces, pudding, confections, nutrition bars, snacks, supplements and other foods with a protein component. A beverage or similar food made from the composition can optionally be carbonated using carbon dioxide gas.

### EXAMPLES

### Example 1

### Protein Concentrate from Skim Milk

Pasteurized skim milk having the following composition is obtained from routine dairy operations.

TABLE 1

| | Amount/100 g composition | Amount/100 g solids |
|---|---|---|
| Total Solids | 9.1 g | — |
| Protein | 3.5 g | 38.5 g |
| Fat | 0.1 g | 1.1 g |
| Ash | 0.7 g | 7.7 g |
| Lactose | 4.4 g | 48.4 g |
| Other | 0.3 g | 3.3 g |

Fifty liters of the pasteurized skim milk is forewarmed by heating to 95° C. (203° F.) and holding the milk at that temperature for twenty minutes. The heated milk is then cooled to about 10° C. (50° F.) in preparation for filtration.

### Ultrafiltration Stage

A spiral wound polyethylene sulfone membrane having a 100,000 MWCO is used for the ultrafiltration processing. This membrane has a surface area of approximately 5 square meters. Membrane filtration is performed at a feed rate of about 2.5 liters per second with a back pressure of 30 psi (approximately 200 kilodaltons [to what does this refer?]). The cooled skim milk is concentrated by this ultrafiltration process to reduce the volume of the milk to 25% of the original volume. The material retained by the membrane has the following composition:

TABLE 2

| | Amount/100 g composition | Amount/100 g solids |
|---|---|---|
| Total Solids | 19.2 g | — |
| Protein | 13.2 g | 68.9 g |
| Fat | 0.3 g | 1.6 g |
| Ash | 1.4 g | 7.3 g |
| Lactose | 4.3 g | 22.4 g |

### Diafiltration Stage

The filtration process is continued by adding water to the retentate at the same rate that the fluid passes through the membrane, so as to maintain the retentate volume. The retentate is processed by diafiltration until the protein in the retentate increases to about 80% of the solids. The material retained by the membrane has the following composition:

TABLE 3

| | Amount/100 g composition | Amount/100 g solids |
|---|---|---|
| Total Solids | 16.7 g | — |
| Protein | 13.0 g | 77.8 g |
| Fat | 0.3 g | 1.8 g |
| Ash | 1.2 g | 7.2 g |
| Lactose | 2.2 g | 13.2 g |

Analysis of the retentate shows that between 15% and 20% of the protein retained is whey protein, and the rest can be categorized as casein. This represents about an 80% retention of the starting milk whey protein and about 100% retention of the starting milk casein. The concentration of lactose in the retentate is approximately 10% of the lactose that would be in the same volume of starting milk.

### Example 2

### Comparative Example without Heating

Fifty liters of pasteurized skim milk with the same composition as that used in Example 1 above is cooled to about 10° C. without being given the forewarming treatment of

Example 1. The skim milk is processed by ultrafiltration using the same process and equipment used in Example 1 to reduce the volume of the milk to one-fourth of the original volume. The retentate is processed by diafiltration using the same amount of water that was used in Example 1. The material retained by the membrane has the following composition:

TABLE 4

| | Amount/100 g composition | Amount/100 g solids |
|---|---|---|
| Total Solids | 15.4 g | |
| Protein | 11.7 g | 75.9 g |
| Fat | 0.3 g | 1.9 g |
| Ash | 1.1 g | 7.1 g |
| Lactose | 2.3 g | 14.9 g |

The retentate of Example 2 has a lower protein content than the retentate of Example 1, indicating that more of the protein has been lost to the permeate. In order to obtain the same level of protein as a percent of solids, additional water would be needed during the diafiltration step for preferential removal of lactose.

### Example 3

### Protein Concentrate from Skim Milk with Forewarming and Microfiltration

Pasteurized skim milk with approximately the same composition as that used in Example 1 is forewarmed by heating the milk to 140° C. (280° F.) and holding the milk at that temperature for thirty seconds. The heated milk is then cooled to about 50° C. (40° F.). The system is operated at about 70 kPa pressure with a cross flow rate of approximately 5 meters per second.

The skim milk is then concentrated to one-fourth of the original volume by microfiltration. Microfiltration is a process that is typically used in the treatment of water to remove bacteria. Microfiltration uses either polymeric membranes or porous tubes with a coating selected from inert materials that are packed on the surface of the tube to form a layer with channels that have closely defined size characteristics. The membranes or layers are made with consistently sized pores and depending on the microfiltration material and the method of preparation, the pores for a micro filter range in size from 0.1 microns to 10 microns. [Ralph: do you have an MWCO we can give here for ease of comparison?] The equipment for microfiltration is similar to the equipment for ultrafiltration.

A polymeric membrane with a mean pore size of 0.1 micron and about 0.5 square meters of surface is used in this Example. The material retained by the membrane has the following composition:

TABLE 5

| | Amount/100 g composition | Amount/100 g solids |
|---|---|---|
| Total Solids | 19.1 g | — |
| Protein | 13.0 g | 68.1 g |
| Fat | 0.3 g | 1.6 g |
| Ash | 1.5 g | 7.8 g |
| Lactose | 4.2 g | 21.9 g |

Analysis of the retentate shows that between 18% and 20% of the protein retained is whey protein, and the rest can be categorized as casein. This represents about a 90% retention of the starting whey protein, with about 100% retention of the casein. The concentration of lactose in the retentate is approximately the same as the concentration of lactose in the starting milk, showing that lactose is not retained by the microfiltration filter.

### Example 4

### Comparative Microfiltration Example without Heating

Fifty liters of pasteurized skim milk with approximately the same composition as that used in Example 3 is warmed to 40° C. without being given the forewarming treatment of Example 3. The skim milk is concentrated using the same microfiltration equipment used in

Example 3 and under approximately the same conditions of pressure, cross flow rate and concentration. The skim milk volume is reduced to one-fourth of its original value by this process. The material retained by the membrane has the following composition:

TABLE 6

| | Amount/100 g composition | Amount/100 g solids |
|---|---|---|
| Total Solids | 18.2 g | — |
| Protein | 12.1 g | 66.5 g |
| Fat | 0.3 g | 1.6 g |
| Ash | 1.5 g | 8.2 g |
| Lactose | 4.3 g | 23.6 g |

The retentate of Example 4 has a lower protein content than the retentate of Example 3, indicating that more of the protein has been lost to the permeate. Only about 10% of the Whey Proteins and 100% of the Casein Proteins are retained by the microfiltration system. The concentration of lactose in the retentate is approximately the same as the concentration of lactose in the starting milk, showing that lactose was not retained by the filter.

### Example 5

### Heat and Storage Stability

Commercial Milk Protein Isolates are used as part of or all of the protein source in nutritional foods. Examples of nutritional foods include food bars, gels, shakes and beverages that are made by the consumer from powder mixtures or that are ready to drink liquids. Ready to drink liquids are typically sterilized and packed into metal or plastic containers that can be stored at room temperature until being consumed or until being cooled for consumption. Commercial Milk Protein Isolates can be produced by ultrafiltration and diafiltration of skim milk.

A commercial Milk Protein Isolate (MPI) obtained from Milk Specialties (Eden Prairie, Wis.) is dispersed into cold water to give the following composition:

TABLE 7

| | Amount/100 g composition | Amount/100 g solids |
|---|---|---|
| Total Solids | 14.4 g | — |
| Protein | 12.9 g | 90.0 g |
| Fat | 0.2 g | 1.4 g |
| Ash | 1.2 g | 8.3 g |
| Lactose | 0.2 g | 1.4 g |

A concentrated retentate from each of the Examples above is diluted with water to make a composition having 10 g of protein per 100 g of solution. Five to ten milliliters of each is sealed in a glass tube with a screw cap, and the tube is mounted on an apparatus that gently rocks the tube in an oil bath maintained at 115° C. The time is then noted when the liquid in the tube first showed aggregation or lumps, and this is reported as the Heat Stability Time in the table below [Ralph: these examples appear to be misnamed in the next two tables (e.g. Example 1 was forewarmed). Please confirm before I correct these]:

TABLE 8

| Milk Protein Composition | Heat Stability Time (min) |
|---|---|
| Example 2 Ultrafiltered Skim | 20-25 |
| Forewarmed at 95° C. | |
| Example 1 Ultrafiltered Skim | 2-4 |
| Example 4 Microfiltered Skim | 15-20 |
| Forewarmed at 140° C. | |
| Example 3 Microfiltered Skim | 4-6 |
| Commercial MPI | 2-4 |

### Example 6

### Heat Stability of Example Retentates Formulated into a Model Liquid

In another heat stability test, a model nutritional liquid is formulated using the Example concentrates with added Water, tri-calcium phosphate, maltodextrin, and canola oil to produce a composition with the following nutrient levels in each 1000 grams of model liquid.

TABLE 9

| | Amount/1000 g | Amount/400 g |
|---|---|---|
| Nutrient | Liquid | Liquid |
| Protein | 62.5 g | 25 g |
| Carbohydrate | 25 g | 10 g |
| Fat | 25 g | 10 g |
| Calcium | 0.63 g | 0.25 g |

Each formulated Model Liquid is pasteurized (63° C. for 30 minutes) and homogenized prior to testing. Heat stability is tested using the protocol of Example 5 and yields the following results:

TABLE 10

| Example Concentrate Used | Heat Stability Time (min) |
|---|---|
| Example 2 Ultrafiltered Skim | 15-20 |
| Forewarmed at 95° C. | |
| Example 1 Ultrafiltered Skim | 2-3 |
| Example 4 Microfiltered Skim | 10-15 |
| Forewarmed at 140° C. | |
| Example 3 Microfiltered Skim | 3-4 |
| Example 5 Commercial Isolate | 2-4 |

Due to the short heat stability times for the concentrates made without forewarming the skim milk, liquid formulations that use these concentrates are expected to have less than a three-month shelf lives before the liquids would develop a high viscosity or develop lumps or gels that are perceived by consumers as defective. In contrast, the longer heat stability times for concentrates that were first heated indicate that this forewarming step is advantageous in allowing a long shelf life for a nutritional liquid without the requirement to stabilize the formulation with added phosphates, poly phosphates or citrate salts.

### Example 7

### Lactose-Free Concentrates

The protein to lactose ratios for compositions in the Examples above are as follows:

TABLE 11

| | | Protein to |
|---|---|---|
| Example | Description | Lactose Ratio |
| | skim milk | 0.7 |
| 1 | Forewarmed and concentrated | 3.1 |
| | by ultrafiltration (UF) before | |
| | diafiltering | |
| 1 | Forewarmed, concentrated by | 5.9 |
| | UF, after diafiltering | |
| 2 | Not forewarmed, concentrated | 5.1 |
| | by UF and diafiltered as in | |
| | Example 1 | |
| 3 | Forewarmed and concentrated | 3.1 |
| | by microfiltration | |
| 4 | Not forwarmed, concentrated | 2.8 |
| | by microfiltration as in | |
| | Example 3 | |
| 5 | Commercial Milk Isolate | 64 |

Comparing the protein-to-lactose ratios for the various examples demonstrates two benefits of heating the milk prior to membrane treatment. First, similar membrane processes (1 vs 2 and 3 vs 4), forewarming resulted in a higher level of protein in the retenate and also results in a higher ratio of protein to lactose. Membrane processing of forewarmed skim milk is more effective in protein retention than membrane processing skim milk that has not been forewarmed, because the whey proteins are associated with or bound to the caseins so that even the small molecular weight whey proteins do not pass through the membrane. Second, the forewarmed and concentrated skim milk produced the same protein-to-lactose ratio with 4× concentration with both ultrafiltration and microfiltration, indicating that highly efficient removal of lactose from milk proteins is less dependent on the type of membrane used. Therefore, the most efficient processing equipment can be used for either concentrating or diafiltering forewarmed skim milk.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1-17. (canceled)

18. A method for making a low-lactose milk protein concentrate, comprising:
providing a liquid milk composition having a pH of from about 6.5 to about 7.0 and comprising initial solids including whey protein, caseins, and lactose, where the lactose is present in an amount of from 9 wt % to about 25 wt % of the initial solids.
heating the liquid milk composition at the pH to a temperature that causes the whey protein to adhere to the caseins, producing protein aggregates in the liquid milk composition;
cooling the liquid milk composition;
subjecting the liquid milk composition to membrane filtration using a membrane filter having a molecular weight cut-off of from about 100,000 to about 1,000,000 daltons;
retaining the protein aggregates to yield a milk protein concentrate comprising retained solids and less than about 5 wt % moisture, and having a total protein content of from about 60 wt % to about 90 wt % of the retained solids; and
adding an amount of lactase sufficient to reduce the amount of lactose to less than about 2 wt % relative to the total protein content.

19. The method of claim 18, wherein the liquid milk composition is a skim milk.

20. The method of claim 18, wherein the liquid milk composition is a liquid milk protein concentrate including solids comprising from about 42 wt % to about 70 wt % protein.

21. The method of claim 18, wherein the liquid milk composition is a milk to which whey protein has been added.

22. The method of claim 18, wherein the temperature is from about 80° C. to about 150° C.

23. The method of claim 18, wherein the membrane filtration is ultrafiltration.

24. The method of claim 23, wherein the membrane filtration includes ultrafiltration followed by diafiltration.

25. The method of claim 18, further comprising decreasing the pH to between about 5.0 and about 6.5 after cooling the liquid milk composition.

26. The method of claim 25, wherein decreasing the pH is accomplished by adding a calcium-binding buffer to the liquid milk composition.

27. The method of claim 26, wherein the calcium binding buffer is a citrate buffer.

28. The method of claim 25, wherein decreasing the pH is accomplished by adding an acid to the liquid milk composition.

29. The method of claim 18, wherein the milk protein concentrate has a total protein content of from about 65 wt % to about 75 wt % of the retained solids.

30. The method of claim 18, wherein the milk protein concentrate has a total protein content of about 70 wt % of the retained solids.

31. The method of claim 18, wherein the milk protein concentrate is substantially free of whey protein cross-linking.

32. The method of claim 18, further comprising drying the milk protein concentrate to yield a powder.

33-39. (canceled)

40. A nutritional product including a milk protein concentrate, said milk protein concentrate comprising:
solids including a total protein content of about 60 wt % to about 80 wt %, said total protein content comprising caseins and whey protein; and
lactose present at less than about 2 wt % relative to the total protein content.

41. The nutritional product of claim 40, further comprising at least one additive selected from the group consisting of: flavoring, carbohydrates, fat, vitamins, minerals, and carbon dioxide gas.

42. A method of reducing gel formation in a milk product during storage comprising:
providing a liquid milk composition having a pH of from about 6.5 to about 7.0 and comprising whey protein, caseins, and lactose;
heating the liquid milk composition at the pH to a temperature that causes the whey protein to adhere to the caseins, producing protein aggregates in the liquid milk composition;
cooling the liquid milk composition;
subjecting the liquid milk composition to membrane filtration using a membrane filter having a molecular weight cut-off of from about 100,000 to about 1,000,000 daltons; and
retaining the protein aggregates to yield a milk protein concentrate comprising retained solids and less than about 5 wt % moisture, and having a total protein content of from about 60 wt % to about 90 wt % of the retained solids,
wherein the milk protein concentrate remains substantially free of gelation over a storage period.

43. The method of claim 42, wherein the storage period is up to about 200 days.

44. The method of claim 42, wherein the milk protein concentrate is substantially free of whey protein cross-linking.

45. The nutritional product of claim 40, wherein the whey protein is present in an amount of about 15 wt % to about 25 wt % of the solids.

46. The nutritional product of claim 40, wherein the whey protein and caseins are bound together in protein aggregates.

47. The nutritional product of claim 40, wherein substantially all of the whey protein present is bound in the protein aggregates.

48. The nutritional product of claim 40, wherein the lactose is present at less than about 1 wt % relative to the total protein content.

49. The nutritional product of claim 40, wherein the milk protein concentrate is a dry powder.
